(19) United States
(12) Patent Application Publication
(10) Pub. No.: US 2005/0253385 A1
(43) Pub. Date: Nov. 17, 2005

(54) Device for connecting pipelines such that relative motion is allowed, comprising a pretensioning device such that constant sealing gap can be provided

(76) Inventor: Sigmund Larsen, Kiel (DE)

Correspondence Address: Jeffrey Pearce, 34825 Sultan-Startup Road, Sultan, WA, 98294, US

(21) Appl. No.: 10/513,386

(22) PCT Filed: May 6, 2003
(86) PCT No.: PCT/NO03/00146

§ 371 Date: Apr. 25, 2005

(30) Foreign Application Priority Data
May 8, 2002 (NO) 20022196

(51) Int. Cl. F16L 27/10

(52) U.S. Cl. 285/223

(57) ABSTRACT

Device for connecting pipelines conducting fluid under pressure, such that relative movement is allowed between two coupling parts carrying respective coupling ends of the pipelines, with possibility for pressure testing of primary seals before operation, wherein a first of the coupling parts is comprising a central core (1) provided with a bore (60) in longitudinal direction and a radial passage (61) with fluid connection to the longitudinal bore (60), which radial passage (61) has fluid connection with a ring formed passage (62) formed in a second ring formed coupling part (2) that is movable relative to the first coupling part, where facing axial surfaces (surfaces substantially normal to the longitudinal axis) between the second connection part and both the first connection part and an additional part comprising dynamic hydraulic test seals (20, 21), dynamic hydraulic primary seals (22, 23) and dynamic hydraulic secondary seals (24, 25), have constant sealing gap for the dynamic seals (20, 21, 22, 23, 24, 25) independent of the fluid pressure in the passage (62) in the second coupling part, distinguished in that the device is comprising a relative to the first coupling part stationary bearing ring (3), arranged over the second coupling part and equipped with axial pretensioning against the second coupling part with at least one spring and having construction allowing supply of a compensator fluid to a compensator gap that in substance is arranged parallel with the sealing planes and with the bearing ring between the compensator gap and the sealing planes, such that a constant sealing gap can be provided with pretensioning and compensator fluid for all fluid pressures.

The present invention regards a device for connecting pipelines that are transporting fluid between two mutually movable units or parts. Such devices for connections are required for transfer of fluid from a subsea production site, via a riser to an offshore drilling or production vessel, whereby the requirement is that the vessel can rotate freely with respect to weather and wind, independent of the riser and the subsea installations. The ability to rotate in the connection device is particularly beneficial, in that no limitations are imposed on the vessel. Other alternatives can be the use of flexible hoses in suitable devices, for example a slip chain, but such a device causes limitation with respect to maximum rotation, typically ±270° C.

Such devices for connection entail severe requirements as to dynamic seals that are sealing against leakage of oil or gas to the environment, as this otherwise potentially can result in damage to health, environment and values, and under all circumstances the process has to be shut down while repairs are undertaken. Such connections are often large constructions with narrow tolerances. Mistakes during assembling and harsh operational conditions for the dynamic seals, such as variations in the seal gap, can result in damage on the sealing material and loss of ability to seal.

To increase the service life for such seals and increase the safety of the process, it is crucial that the operating conditions for the dynamic seals are as beneficial and constant as possible.

Several rotating devices for connecting fluids are known, for example as apparent from patent application No. 964,616. Common for the known devices are that the dynamic seals encounter variations in the gap against which they are to seal. Because of internal pressure in the connection devices during operation, the seal gap between the mutually movable rings will increase and worsen the conditions for the seals. At repeated and large variations in internal pressure, the seal gap will continuously change. This will wear out the seals over time, which will eventually result in malfunction and in worst case leakage.

Further, the prior art fluid connection devices are comprising a large number of rings, even for one bore connections, which results in expensive devices.

The objective of the present invention is to provide an improved construction where the above mentioned disadvantages in substance are avoided. The invention is comprising a device for fluid connection with possibility of testing the primary seal before operation. Further, a spring package is pretensioning the assembly, providing a constant pressure on the dynamic seals when the connection is not in operation. When the fluid connection device is in operation and under influence of process pressure, compensation fluid is introduced under pressure to a compensating gap to balance the internal process pressure, such that the pressure on the seals remains constant, independent on whether the connection device is in operation or not. Variations in the process pressure can be handled, and the supply pressure of compensation fluid can be regulated according to the process pressure. The gap between the mutually movable rings will then remain constant and the wear on the seals be minimized. The number of seals is also minimized with respect to production feasibility and cost.

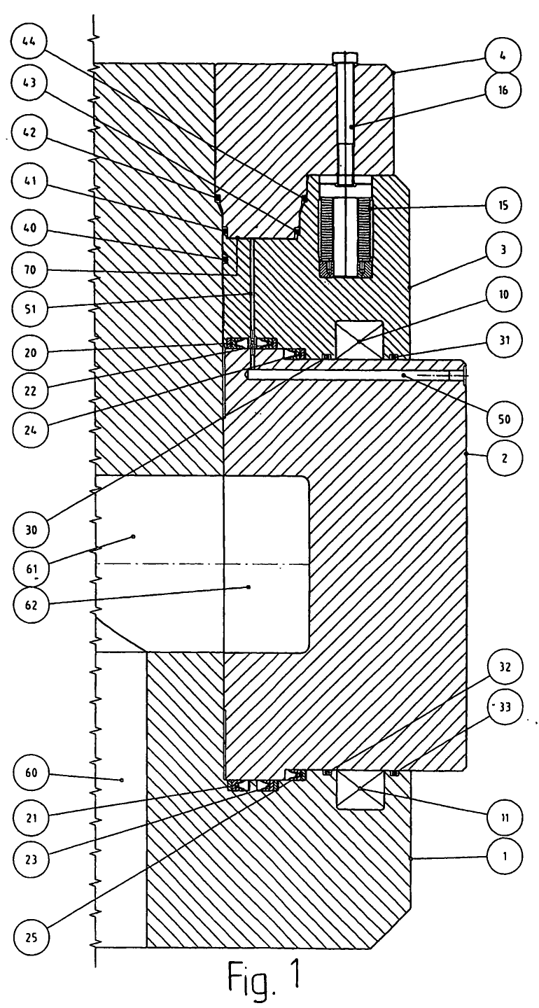

Reference is made to the drawing FIG. 1, illustrating the connection device.

The fluid connection device is constructed of a core 1 having a bore 60 in the longitudinal direction, being in connection with a radial bore 61. An outlet ring 2 with a ring formed passage 62 is connected to the core 1 such that relative movements are allowed. An upper and a lower bearing 10, 11 provide a low friction bearing of the outlet ring 2.

In the core 1 a groove is provided for dynamic seals; the test seal 21, the primary seal 23 and the secondary seal 25, radially arranged between the core 1 and the outlet ring 2. Further, seals 32, 33 around bearing 11 are provided to seal against contaminations from the environment, and to maintain the lubricant in the bearing 11.

Over the outlet ring 2 is the bearing ring 3. This is stationary with respect to the core 1. The bearing ring 3 has a groove for the dynamic seals; the test seal 20, the primary seal 22 and the secondary seal 24, arranged between the outlet ring 2 and the bearing ring 3. Further, the bearing ring is provided with bores for a number of spring packages 15. The spring packages 15 are positioned axially and are pretensioned by use of an adjustment bolt 16. These provide a constant axial pressure between the bearing ring 3 and the outlet ring 2, and between the outlet ring 2 and core 1.

Similar as for the lower bearing ring 1, seals 30, 31 are provided with the bearing ring 10, one on either side.

Over the bearing ring 3 is a compensator ring 4 arranged. This is also stationary with respect to the core 1. The compensator ring 4 is provided with grooves for the adjustment bolt 16 providing pretension to the spring package 15.

In the outlet ring 2 a horizontal bore 50 having vertical connection to the radial opening between the test seal 20 and the primary seal 22 is provided. By adding liquid or gas under pressure in said opening prior to transfer of process fluid between the core 1 and the outlet ring 2, the primary seal 22 can be tested with respect to being leakproof. A similar arrangement with bore 51 is provided in the lower part of the outlet ring 2 for testing of the primary seal 23.

The test seal 20 (21) is situated with the “back” towards the process fluid, allowing to maintain a test pressure between the test seal 20 (21) and the primary seal 22 (23).

The bore 50 has further a vertical connection to the compensator gap 70 between the bearing ring 3 and the compensator ring 4, between the seals 41 and 43. By supplying a compensator fluid under pressure to the compensator gap, to compensate for the increased internal process fluid pressure and assist the spring package, can the axial gap between the outlet ring 2 and the core 1, and the axial gap between the outlet ring 2 and the bearing ring 3, be maintained constant under operation even at large process pressure. Thereby the operating conditions of the dynamic seals 22, 23, 24, 25 are optimized.

The compensator gap between the bearing ring 3 and the compensator ring 4 has a double barrier with the sealing pairs 41, 42 and 43, 44, to avoid leakage of the compensator fluid to the environment. Further, a seal 40 between the bearing ring 3 and the core 1 is provided to avoid leakage of compensator fluid to the process fluid. The seal 40 will also hinder leakage of process fluid to the compensator gap 70.

Further, grooves are provided for static seals 43, 44 between the bearing ring 3 and the compensator ring 4, and for the static seals 41, 42 between the core 1 and the compensator ring 4. The static seals are provided to hinder process fluid to enter the environment.

1. (canceled)

2. Device according to claim 7, in which the tensioning arrangement comprises a plurality of springs arranged concentrically with respect to the central core.

3. Device according to claim 7, in which the tensioning arrangement comprises a single spring of larger diameter than the central core.

4. Device according to claim 2, in which the springs are disk springs.

5. Device according to claim 7, in which the compensator fluid is supplied from an external source.

6. Device according to claim 7, in which the pre-tensioning pressure of the tensioning arrangement is adjustable.

7. Device for connecting ends of pipelines, which conduct fluid under pressure, comprising:
a first coupling part that is connected to a first one of the pipeline ends and that has a central core and a longitudinally extending bore;
a second coupling part that is connected to a second one of the pipeline ends, that is movable relative to the first coupling part, and that has a ring-shaped passage;
a radially extending passage in fluid communication with the bore and with the ring-shaped passage;
a bearing ring that is stationary relative to the first coupling part;
a sealing gap extending between the second coupling part and both the first coupling part and the bearing ring;
a plurality of seals facing the sealing gap;
a tensioning arrangement that has at least one spring;
a compensator gap in fluid communication with a supply of compensator fluid and transmitting a compensation pressure;
in which:
the tensioning arrangement applies pre-tensioning pressure to the second coupling part substantially parallel to sealing planes of the plurality of seals;
the compensator fluid in the compensator gap and the tensioning arrangement thereby cooperating to maintain the sealing gap constant over the full range of operating pressures of the fluid conducted by the connected pipelines.

8. Device according to claim 7, in which the compensator fluid is supplied as a portion of the pressurized fluid carried by the pipelines.

9. A device as in claim 7, in which the plurality of seals includes dynamic hydraulic test seals, dynamic hydraulic primary seals, and dynamic hydraulic secondary seals.
